(19) United States
(12) Patent Application Publication
(10) Pub. No.: US 2010/0232163 A1
(43) Pub. Date: Sep. 16, 2010

(54) LIGHTING DEVICE WITH REFLECTOR AND METAL HOUSING

(75) Inventors: GRETA JOANNA MARIA S'HEEREN, TURNHOUT (BE); TEUNIS ADRIANUS KASSENAAR, NUENEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/303,557

(22) PCT Filed: May 31, 2007
(86) PCT No.: PCT/IB07/52051

§ 371 Date: Dec. 5, 2008

(30) Foreign Application Priority Data
Jun. 7, 2006 (EP) 06115068.6

(51) Int. Cl. F21V 29/00; F21V 7/00

(52) U.S. Cl. 362/294; 362/296.01

(57) ABSTRACT

A lighting device (1) comprising a lamp (10) for emitting light and a concave reflector (20) accommodating said lamp. The reflector has a neck part (21), a reflective part (22) and a light emission window (23). The reflective part has an outer surface (24). A transversal, transparent front plate (25) is provided at the side of the light emission window. A metal housing (30) having a wall (31) is provided around said reflector. At least 50%, preferably at least 70%, of the outer surface of the reflective part is clad by the wall of the metal housing. The transparent front plate may be arranged in an extension part (35) of the housing and can be tilted with respect to the light emission window axis at an angle α in the range of 2° to 25°, preferably in the range of 4° to 10°.

The invention relates to a lighting device as defined in the pre-characterizing part of claim 1.

Such a lighting device is known from WO2005101457. High-pressure discharge lamps used in video projectors or projection televisions are liable to explosion, which may result in hot glass fragments being scattered around. If such an explosion causes breakage of the glass reflector or the transparent front plate, the hot glass fragments may cause fire or harm people when these fragments fall outside the projector or television. In the known lighting device, this is counteracted by enclosing the lamp and the reflector in a metal housing. However, said housing increases the problem of thermal management of the lamp and the lighting device. During operation, the lamp generates heat and becomes hot. When the lighting device becomes (locally) too hot, the lifetime of the lamp is decreased. In the known lighting device, the metal housing is provided with cooling fins on its outer surface and is connected to the reflector via thermal bridges to allow heat to be conducted away from the lamp so as to cope with the problem of thermal management of the lighting device and the lamp. Due to this problem, the known lighting device has a complicated structure and must be comparatively spacious, which is a drawback.

Other known lighting devices, for example, as disclosed in US20060109656, cope with the thermal management problem by providing the housing with vent holes and cooling fans. When a fan is used for cooling the lamp, the problem arises that stray light may issue from the lighting device and that there may be a direct line of sight between an end user and the lamp itself These contradictory requirements of open air passages and blocking light are often solved by using louver-like constructions. Such constructions have the disadvantage of a complicated structure, a large space and a high cost. Sometimes, fans with special overlapping light-blocking blades are necessary. Such fans are even more expensive than regular ones.

It is an object of the invention to provide a lighting device of the type described in the opening paragraph, in which the disadvantages of the known lighting devices are counteracted. To this end, the lighting device mentioned in the opening paragraph is defined in the characterizing part of claim 1.

Since glass is a poor heat conductor, both the lamp and the reflector have no even temperature, i.e. they have local hot spots. The lamp having its hot spot in its wall between the electrodes, and the reflector having its hot spot adjacent the neck which is shifted some millimeters, for example, 5 mm to 7 mm, towards the light emission window, i.e. in the vicinity of the focal point of the reflector in which the discharge path of the lamp is located. Said hot spots may cause excessive stresses in the material, which may lead to lamp failure. The occurrence of said hot spots is counteracted by a metal housing cladding of at least 50% of the glass surface of the reflective part of the reflector, i.e. it is present at a close distance from the outer surface of the reflective part without a substantial (isolating) (air)gas layer between the outer reflective part and the metal housing. As radiation is the major heat transfer mechanism, this will result in the heat being more evenly spread over the reflector so that the hot spots will have a lower temperature, i.e. thermal management of the lighting device is improved. Experiments proved that the temperature of the hot spot decreased by about 110° C. in the case a cladding of about 70%, i.e. the temperature of the hot(test) spot on the reflector decreased from 308° C. to 200° C. When more than 70% of the reflective part is clad by the metal wall of the housing, thermal management of the lighting device is still further improved. Furthermore, the lighting device of the invention has a housing which at least partly follows the outer contours of the reflector, resulting in a relatively small housing, i.e. it is far less spacious than the housing of known lighting devices. In addition, the housing counteracts, in a simple way, undesired exposure of humans to stray light and/or UV radiation generated by the lamp.

In a preferred embodiment, the lighting device is characterized in that the housing is provided with an extension part extending in the axial direction beyond the light emission window, in which extension part the transparent front plate is located. The extension part as well as the housing may be made of aluminum, tin plate, stainless steel or any other suitable metal. The extension part is preferably provided with means for keeping the transparent front plate in a preferred position, said means being, for example, click legs which allow easy fixation of the transparent plate inside the extension part. To improve cooling, the thermal absorption/emission coefficient of the extension part is increased, for example, in that the extension part is made of aluminum, which can be additionally anodized, or other materials which may be painted with a heat-resistant paint having a high emission/absorption coefficient. Alternatively or additionally, the extension part is provided with vent openings, for example, holes or slits, to allow cooling air to pass through the lamp. In a further embodiment, a separate metal part which combines the functions of metal grid and click leg can be used. The vent openings should have a limited size, so that glass fragments which are larger than, for example, 10 mm³, preferably less than 5 mm³, are confined within the housing in the case of explosion of the lamp.

In an embodiment, the lighting device is characterized in that the extension part is connected to the housing by means of welding, crimping or folding after the housing, the extension part and the transparent front plate have been put into place. A relatively robust extended housing is then obtained as compared to an extension part which is clicked onto the housing. In the case of explosion of the lamp, the extended housing is able to withstand said explosion relatively well so that glass fragments are confined within the housing to a relatively large extent.

In a further preferred embodiment, the lighting device is characterized in that the position of the transparent front plate is tilted with respect to the optical axis by an angle in the range of 2° to 25°, preferably in the range of 4° to 10°. The effect of back reflection on (relatively hot) parts of the lamp, for example, a front seal of the lamp, which might cause an increase in temperature of the lamp, is thus reduced. To further reduce this back reflection, the transparent front plate is provided with an anti-reflection coating, preferably at the side of the transparent front plate facing the lamp. Preferably, the anti-reflection coating additionally reflects or absorbs UV radiation so as to counteract incident exposure of humans to said UV-radiation. More preferably, the coating absorbs UV-radiation so as to reduce back-reflection onto lamp parts and thus to obtain a lower temperature of the lamp.

In a further embodiment, the lighting device is characterized in that the neck has a protruding part which extends to the exterior of the housing in an axial direction, the protruding part being provided with a base. Said base can be provided with means that allow its use in standardized lamp holders, for example, a bayonet-like fitting or an Edison-like fitting. Manufacturers of known video projectors and projection televisions have hitherto solved electric connections of the lighting device inside the projector system by using dedicated lamp holders and lamp compartments. The projection lamp is built into a lamp holder to form a unit which is placed in the lamp compartment of the projector or television system. The known lighting devices have the disadvantage that each lighting device requires a specific lamp holder which hampers interchange of lighting devices between different video projectors and projection televisions. The standard base counteracts this disadvantage. The base preferably has an annular end facing the reflective part, which annular end abuts the metal housing. The base is usually fixed to the neck by means of cementing. The parts of the reflector that are most liable to fracture in the case of explosion of the lamp are fully enclosed by the base, housing and transparent front plate.

In a preferred further embodiment, the lighting device is characterized in that the base has a transversal end face facing away from the reflector, which end face is provided with at least two electric contacts. A unit of lamp and reflector in known lighting devices usually has contact wires or screw contacts as electric connections to the lamp holder. This has the drawback that it is a cumbersome operation to disconnect a unit and connect a new one in the case of lamp failure or at the end of the lamp life. This embodiment of the inventive unit counteracts this drawback because lamp holders can be omitted. It enables manufacturers of video projectors and projection televisions to apply the lighting devices in a much easier and cost-effective way. Skipping the bulky lamp holder allows manufacturers to design smaller, more compact video projectors. Since only the unit is replaced, it will be much easier to come to a worldwide standardization of projection lamps, similar to the standardization of halogen reflector lamps and lamp bases. Contact springs in the lamp compartment press the lamp forward into position and ensure electric contact.

The base may be made of a ceramic material, for example, aluminum oxide, or a suitable thermoplastic material, for example, PPS (Poly Phenylene Sulfide) or LCP (Liquid Crystal Polymer), for lower wattage lamps, i.e. lamps having a nominal power of about 30 W to 50 W. Possible production techniques for the various housings and extension parts may be punching, spinning, deep drawing, die casting, or impact extrusion.

The invention will now be further elucidated with reference to the drawings in which

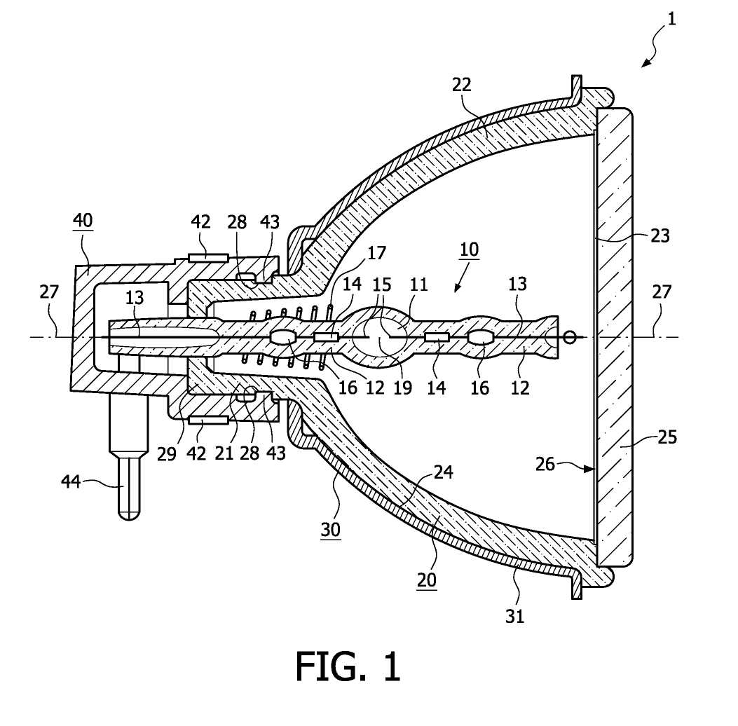

FIG. 1 is a cross-sectional side view of a first embodiment of the lighting device of the invention;

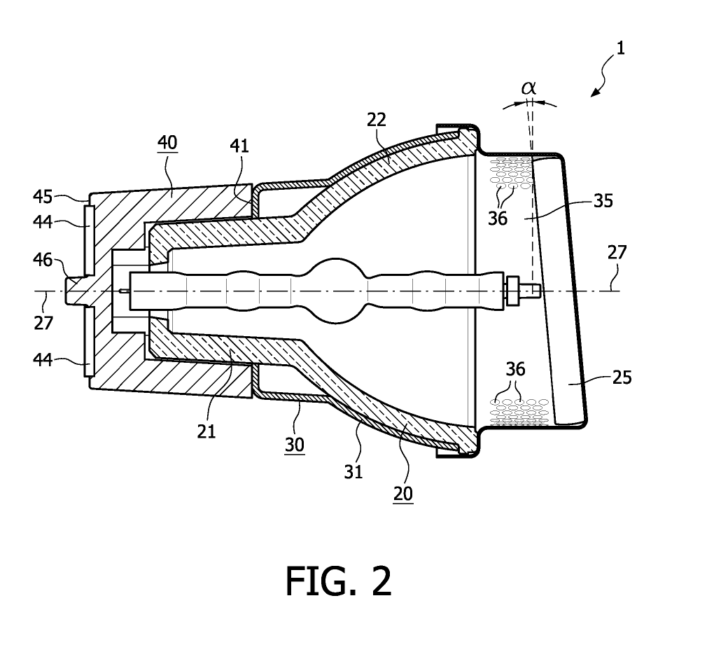

FIG. 2 is a cross-sectional side view of a second embodiment of the lighting device of the invention;

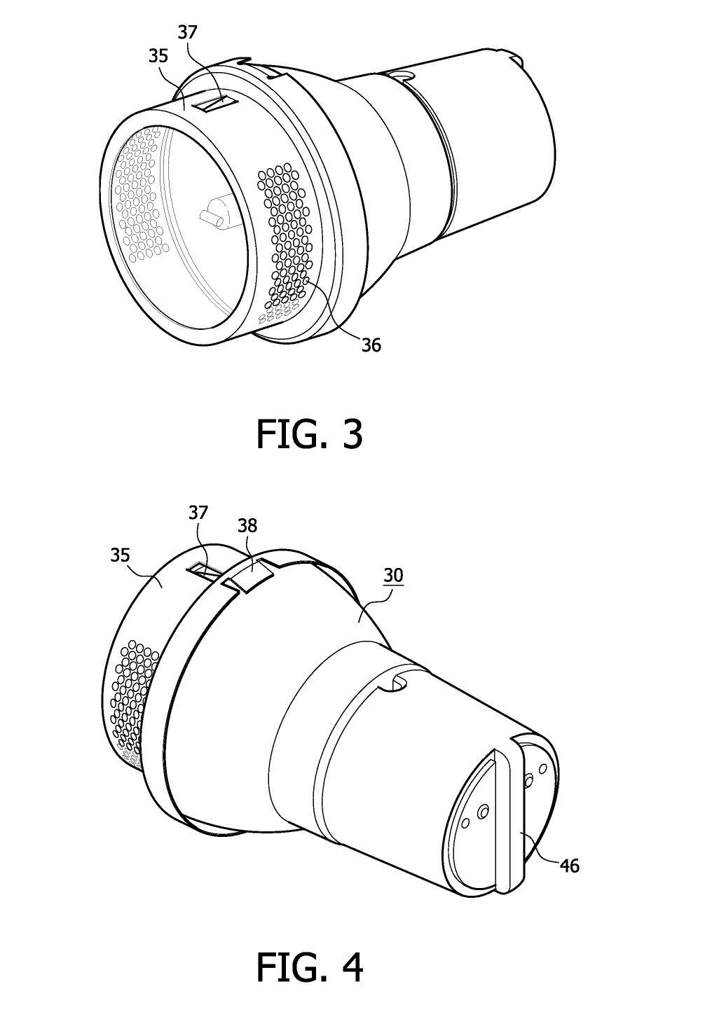

FIG. 3 is a perspective view of the lighting device of FIG. 2 from the side of the light emission window; and

FIG. 4 is a perspective view of the lighting device of FIG. 2 from the side of the lamp base.

FIG. 1 shows a lighting device 1 for projection purposes. The lighting device comprises a lamp 10 for emitting light, in the Figure a short arc high-pressure mercury gas discharge lamp, and a concave reflector 20 accommodating said lamp. The reflector has a neck part 21, a reflective part 22 and a light emission window 23. The reflective part is parabolically shaped and defines a focal point 19 and an optical axis 27 and has an outer surface 24. A transversal, transparent front plate 25 is arranged in the light emission window 23. A metal housing 30 made of, for example, aluminum or stainless steel and having a wall 31 is arranged around said reflector. At least 50% of the outer surface 24 of the reflective part 22 is clad by the wall 31 of the metal housing 30, in the Figure about 90%. “Clad” is herein understood to mean, for example, that the wall of the housing closely follows the outer contours of the outer surface of the reflective part and that the wall abuts said outer surface locally. The transparent front plate 25 and the reflector 20 are made of glass, for example, hard glass, for example, an alumino-silicate or boro-silicate glass. The front glass is provided with a UV-blocking anti-reflection coating 26 on a side of the transparent plate facing the neck part 21/lamp 10. In the Figure, the coating comprises an anti-reflection component, for example, a dichroic coating of alternating SiO2 and TiO2 layers, and a UV-blocking component, for example, a coating named UB4-420/6 or UB4-420/10 by PRINZ. The transparent front plate is fixed to the reflector by means of silicone cement. The lamp 10 is made of quartz glass, i.e. glass having a SiO2 content of at least 95% by weight. The lamp comprises a discharge space 11 sealed by two opposing seals 12 provided with current feedthroughs and comprising molybdenum current conductors 13, molybdenum foils 14 and tungsten electrodes 15 which extend from the discharge space to the exterior of the lamp. The focal point 19 of the reflector is located between the electrodes 15 of the lamp. Each seal further comprises a respective cavity 16, one cavity being surrounded by an antenna 17 which is connected to one of the current conductors and, together with the cavity 16, contributes to (hot re-)ignition of the lamp. One seal of the lamp 10 is fixed in the neck of the reflector, for example, by means of cementing. The neck of the reflector has a protruding part 29 which is provided with a base 40 positioned adjacent but not abutting the housing. The base 40 is made of synthetic resin, for example, PPS of LCP, and is fixed to the neck via a click-construction by means of a metal clamp 42 and fixation grooves 28 into which base projections 43 are fitted. The base further comprises electric contacts 44 for external electric connection. The current conductors 13 are connected to these electric contacts 44. The lighting device is suitable for lamps having a nominal power in the range of 25 W to 500 W. However, the lighting device is intended for lamps having a nominal power in the range of 30 W to 80 W. In the Figure, the lamp of the lighting device has a nominal power of 40 W.

FIG. 2 is a cross-sectional side view of a second embodiment of the lighting device 1 of the invention. In this second embodiment, the lighting device has a nominal power of 80 W. The base 40 is made of ceramic material, i.e. densely sintered aluminum oxide, and is cemented onto the neck 21 of the reflector 20. An annular end 41 of the base abuts the metal housing 30 and has two electric contacts 44 at an end face 45 transverse to the optical axis 27 and facing away from the reflector, the electric contacts being separated by a positioning projection 46. The reflector is encased in the metal housing, and about 60% of the reflective part 22 of the reflector is clad by the wall 31 of said housing. The metal housing 30 is provided with a metal extension part 35 welded onto the housing. In the extension part, the transparent plate 25 is fixed with click legs (see FIGS. 3 and 4) which are tilted with respect to the optical axis 27 by an angle α of 5°. The extension part is provided with a grid of vent openings 36 for cooling the lamp. The openings have a size of 3 mm² or less, and confine the majority of glass fragments that are larger than 3 mm³ within the housing.

FIGS. 3 and 4 are perspective views of the lighting device of FIG. 2 from the side of the light emission window and from the side of the lamp base, respectively. Click legs 37 are shown, which fix the transparent plate inside the extension part. Vent openings 36 extend by about 30% throughout the circumference of the extension part 35. Alternatively, two small slits having a width of, for example, 1 mm extend around the axis across about 50% of the circumference of the extension part. Welding spots 38 are shown, via which the extension part 35 is welded onto the housing 30. Due to its shape, the positioning projection 46 counteracts undesired rotation of the lighting device when it is in mounted position.

1. A lighting device (1) comprising:
a lamp (10) for emitting light;
a concave reflector (20) accommodating said lamp for reflecting light emitted by the lamp during operation, and having a neck part (21), a reflective part (22) and a light emission window (23),
the reflective part defining an optical axis (27) and an axial direction, the reflective part having an outer surface (24) and being located between the neck part and the light emission window,
a transversal, transparent front plate (25) being provided at the side of the light emission window;
a metal housing (30) around said reflector and said lamp and having a wall (31),
characterized in that at least 50%, preferably at least 70%, of the outer surface of the reflective part is clad by the wall of the metal housing.

2. A lighting device as claimed in claim 1, characterized in that the housing is provided with an extension part (35) extending in the axial direction beyond the light emission window, in which extension part the transparent front plate is located.

3. A lighting device as claimed in claim 2, characterized in that the extension part is provided with vent openings (36).

4. A lighting device as claimed in claim 3, characterized in that the transparent front plate is fixed in the extension part by means of click legs (37).

5. A lighting device as claimed in claim 2, 3 or 4, characterized in that the extension part is fixed to the housing by means of welding, crimping or folding.

6. A lighting device as claimed in claim 1, 2, 3, 4 or 5, characterized in that the transparent front plate is tilted with respect to the optical axis by an angle α in the range of 2° to 25°, preferably in the range of 4° to 10°.

7. A lighting device as claimed in any one of the preceding claims, characterized in that the transparent front plate is provided with a UV-blocking anti-reflection coating (26).

8. A lighting device as claimed in any one of the preceding claims, characterized in that the neck has a protruding part (29) which extends to the exterior of the housing in an axial direction, the protruding part being provided with a base (40).

9. A lighting device as claimed in claim 8, characterized in that the base has a transversal end face (45) facing away from the reflector, which end face is provided with at least two electric contacts (44).

10. A lighting device as claimed in claim 8 or 9, characterized in that the base abuts the metal housing.
